(19) United States
(12) Patent Application Publication
(10) Pub. No.: US 2011/0121704 A1
(43) Pub. Date: May 26, 2011

(54) LED LAMP HAVING GOOD HERMETICAL PERFORMANCE

(75) Inventors: ZHONG-QING WANG, Shenzhen City (CN); XIU-YI ZHANG, Shenzhen City (CN); CHIN-CHUNG CHEN, Tu-Cheng (TW)

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/760,532

(22) Filed: Apr. 14, 2010

(30) Foreign Application Priority Data
Nov. 20, 2009 (CN) 200910310137.6

(51) Int. Cl. H01J 61/52; H01J 5/48

(52) U.S. Cl. 313/46; 313/318.01; 313/318.07

(57) ABSTRACT

An LED lamp includes an enclosure, a base connected to a bottom of the enclosure, a cover connected to a top of the enclosure, an LED module received in the enclosure, a cap connected to a base, and a bracket fixed on the enclosure and pressing the cover on the enclosure. A first gasket is sandwiched between the bottom of the enclosure and the base, and a second gasket is sandwiched between the top of the enclosure and the cover. A driving module is received in the enclosure and isolated from the LED module by an interlayer formed in the enclosure.

### BACKGROUND

1. Technical Field

The present disclosure relates to light emitting diode (LED) lamps and, more particularly, to an LED lamp having a good hermetical performance.

2. Description of Related Art

LEDs, available since the early 1960's and because of their high light-emitting efficiency, have been increasingly used in a variety of occasions, such as residential, traffic, commercial, and industrial occasions. For some type lamps, particularly those used in outdoors, good hermetical performance is required for insuring normal operation of the lamps. However, the sealing of the conventional lamps is generally unsatisfied such that dust or moisture in the surrounding environment may enter the lamps, causing reduction in brightness or even malfunction of the lamps.

What is needed, therefore, is an LED lamp having good sealing performance which can overcome the limitations described above.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an assembled view of an LED lamp of the present disclosure.

FIG. 2 is an exploded view of the LED lamp of FIG. 1

FIG. 3 is an inverted view of the LED lamp of FIG. 2

FIG. 4 shows a cross-section of the LED lamp of FIG. 1.

### DETAILED DESCRIPTION OF THE EMBODIMENTS

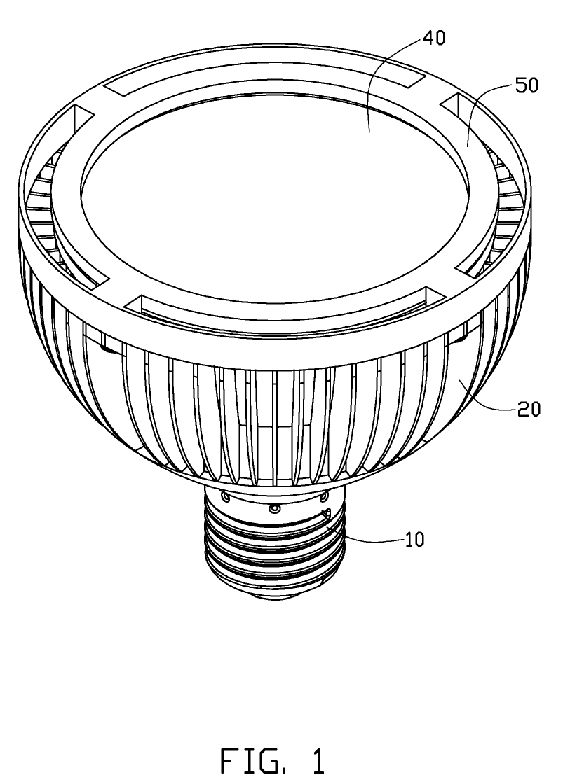

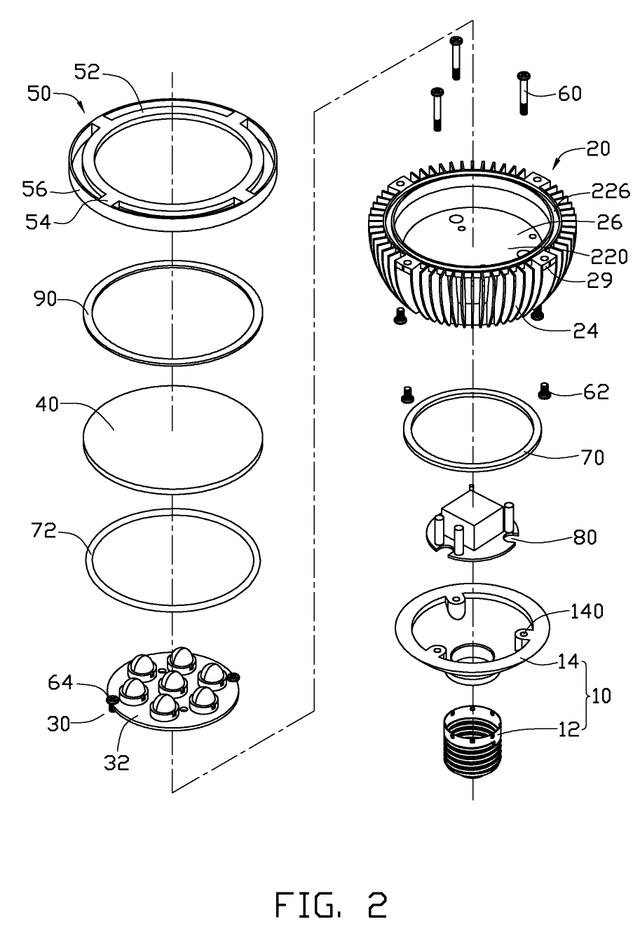

Referring to FIGS. 1-2, an LED lamp of present disclosure is illustrated. The LED lamp includes a support 10, an enclosure 20 fixed on a top of the support 10, an LED module 30 mounted in the enclosure 20, a cover 40 attached on a top of the enclosure 20 and covering the LED module 30 and a bracket 50 fastening the cover 40 on the enclosure 20. The support 10 includes a base 14 and a cap 12 connected to a bottom of the base 14. The base 14 has a bowl-like shape with three protrusions (not labeled) equidistantly extending inwardly from an inner circumference thereof. Each protrusion has a threaded hole 140 defined in a top thereof for extension of a screw 60 into the base 14. The cap 12 is a standard thread-type cap capable of insertion to a typical socket, whereby the LED lamp can obtain electric power from an external power source.

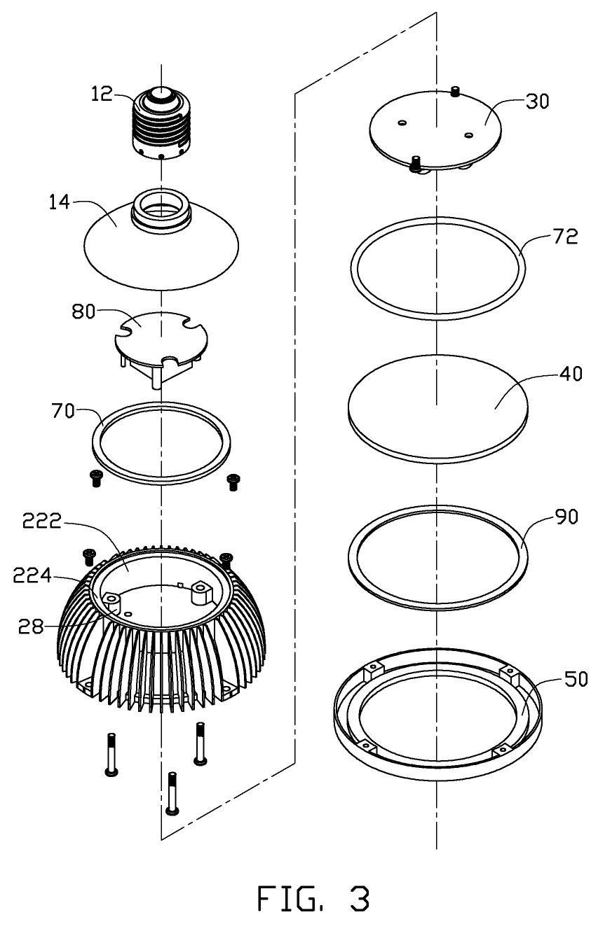

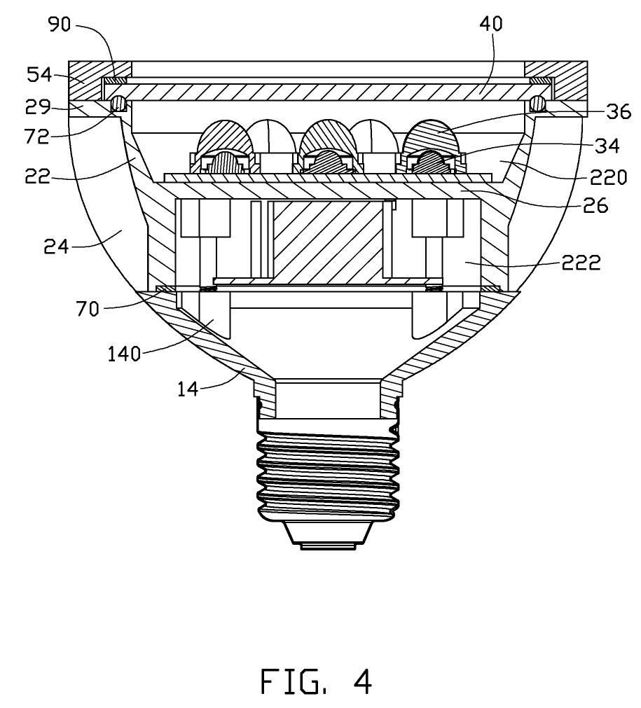

Also referring to FIGS. 3-4, the enclosure 20 is made of heat conducting material such as copper, aluminum or the like. The enclosure 20 includes a hollow column 22 and multiple fins 24 extending radially from an outer circumference of the column 22. The column 22 has a constant inner diameter at a lower portion thereof and an upwardly increasing inner diameter at an upper portion thereof. An interlayer 26 is formed between the upper and lower portions of the column 22 to divide an interior of the column 22 into upper and lower chambers 220, 222. Three ribs 28 are extended inwardly from an inner circumference of the column 22. The three ribs 28 are located in the lower chamber 222 and connected to a bottom of the interlayer 26. Each rib 28 has a through hole (not labeled) therein which also extends through the interlayer 26 and is in alignment with the threaded hole 140 of a corresponding protrusion, for extension of the screw 60 through the interlayer 26 and each rib 28 into the corresponding protrusion, thereby securing the enclosure 20 on the base 14. A bottom of the enclosure 22 defines an annular first groove 224 therein. A first gasket 70 is engagingly received in the first groove 224 to provide a hermetical connection between the base 14 and the enclosure 20. A driving module 80 is received in the lower chamber 222 for providing power to the LED module 30.

The enclosure 20 has an annular second groove 226 defined in a top thereof. Different from the first groove 224 communicating with lower chamber 222, the second groove 226 is spaced from the upper chamber 220 by an inner wall (not labeled) of the enclosure 20. The second groove 226 has a diameter larger than that of the first groove 224 to receive a second gasket 72 larger than the first gasket 70 therein. With the second gasket 72 placed therebetween, the cover 40 and the enclosure 20 are thus hermetically connected. The LED module 30 includes a circular printed circuit board 32, multiple LEDs 34 mounted on a top of the printed circuit board 32 and multiple lenses 36 covering the LEDs 34, respectively (see FIG. 4). The LED module 30 is received in the upper chamber 220 with the printed circuit board 32 thereof fixedly abutting against a top of the interlayer 26 by screws 64. Four blocks 29 are protruded horizontally and outwardly from the outer circumference of the column 22. Each block 29 is located adjacent to a top of the enclosure 20 and interconnects two neighboring fins 24.

The cover 40 is made of transparent material such as glass or plastic. The cover 40 has a circular shape with a diameter thereof larger than that of the second gasket 72 and less than that of a top the enclosure 20. The bracket 50 includes an inner annulus 52, an outer annulus 56 coaxial with the inner annulus 52 and four beams 54 interconnecting the inner annulus 52 and the outer annulus 56. The outer annulus 56 has a height equal to that of the beams 54 and larger than that of the inner annulus 52. Each beam 54 is fixed on a corresponding block 29 of the enclosure 20 by a screw 62 such that the outer annulus 56 is secured on an outer periphery of the top of the enclosure 20 and the inner annulus 52 is driven to press downwardly a periphery of the cover 40, thereby securing the cover 40 on the enclosure 20. A third gasket 90 is provided between the cover 40 and the inner annulus 52 of the bracket 50, functioning as a cushion to relieve pressure produced by the bracket 50 to the cover 40 and a sealer to enhance a hermetical connection between the cover 40 and the bracket 50 thereby further preventing moisture and dust from entering the upper chamber 220.

Since an interface between the base 14 and the bottom of the enclosure 20 and an interface between the cover 40 and the top of the enclosure 20 are both provided with the gaskets 70, 72, the upper and the lower chamber 220, 222 in the enclosure 20 are thus hermetically isolated from an outside environment of the LED lamp, and the LED module 30 and the driving module 80 can accordingly be sealed from the influence by the outside environment, i.e. the dust and moisture or other foreign matter in the outside environment. Thus, the LED module 30 and the driving module 80 can work normally even after a long period of use of the LED lamp in the outside environment.

It is believed that the present disclosure and its advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. An LED (light emitting diode) lamp comprising:
an enclosure;
a base connected to an end of the enclosure;
an LED module received in the enclosure;
a cover connected to an opposite end of the enclosure and covering the LED module;
a first gasket is sandwiched between the base and the enclosure; and
a second gasket is sandwiched between the enclosure and the cover.

2. The LED lamp as claimed in claim 1, wherein the enclosure comprises a hollow column and multiple fins extending radially from the column.

3. The LED lamp as claimed in claim 2, wherein the enclosure further comprises an interlayer connected to the column to divide an interior of the column into two isolated chambers, the LED module being received in one of the two chambers and a driving module being received in the other one of the two chambers.

4. The LED lamp as claimed in claim 3, wherein the enclosure has a first groove defined in the end thereof connected to the base, the first groove communicating with the other one of the two chambers and receiving the first gasket therein.

5. The LED lamp as claimed in claim 3, wherein the enclosure has a second groove defined in the opposite end thereof connected to the cover, the second groove being spaced from the one of the two chambers and receiving the second gasket therein.

6. The LED lamp as claimed in claim 2 further comprising a bracket pressing the cover on the enclosure.

7. The LED lamp as claimed in claim 6, wherein the bracket comprises an inner annulus, an outer annulus and multiple beams connecting the inner annulus with the outer annulus.

8. The LED lamp as claimed in claim 7, wherein the enclosure further comprises multiple blocks between the fins, the beams of the bracket being placed on the blocks and connected thereto and the inner annulus pressing the cover towards the enclosure.

9. The LED lamp as claimed in claim 8, wherein the outer annulus and the beams of the bracket each have a height which is larger than that of the inner annulus.

10. The LED lamp as claimed in claim 8 further comprising a third gasket sandwiched between the inner annulus and the cover.

11. The LED lamp as claimed in claim 1, wherein the LED module comprises a printed circuit board disposed on the interlayer, multiple LEDs mounted on the printed circuit board and plural lens mounted on the printed circuit board and covering the LEDs, respectively.

12. The LED lamp as claimed in claim 1 further comprising a cap connected to the base opposite to the enclosure, the cap being a standard cap capable of mating with a conventional socket to receive electrical power from an external power source.

13. An LED (light emitting diode) lamp comprising:
an enclosure;
a cover and a base connected to two opposite ends of the enclosure, respectively; and
an LED module housed in the enclosure;
wherein an interface between the enclosure and the cover and an interface between the enclosure and the base each are provided with a hermetical material to isolate the LED module from an outside of the lamp.

14. The LED lamp as claimed in claim 13 further comprising a driving module received in the enclosure, wherein the driving module and the LED module are isolated from each other by an interlayer formed in an interior of the enclosure.

15. The LED lamp as claimed in claim 13 further comprising a bracket, wherein the bracket has an inner portion pressing the cover towards the enclosure and an outer portion fixed on the enclosure.

16. The LED lamp as claimed in claim 14, wherein a sealing cushion is sandwiched between the inner portion of the bracket and the cover.

17. The LED lamp as claimed in claim 13, wherein the hermetical material is a gasket.
